(19) United States
(12) Patent Application Publication
(10) Pub. No.: US 2024/0316819 A1
(43) Pub. Date: Sep. 26, 2024

(54) LOG RETAINER APPARATUS

(71) Applicant: Sean MOCHINSKI, Olympia, WA (US)

(72) Inventor: Sean MOCHINSKI, Olympia, WA (US)

(21) Appl. No.: 18/609,125

(22) Filed: Mar. 19, 2024

Related U.S. Application Data
(60) Provisional application No. 63/491,656, filed on Mar. 22, 2023.

(51) Int. Cl. B27L 7/08; B27G 21/00

(52) U.S. Cl. CPC B27L 7/08; B27G 21/00

(57) ABSTRACT

A log retainer apparatus is disclosed herein. The log retainer apparatus may include a plurality of retainer segments, where each retainer segment has a shield connected to a clamp to clamp to an edge of a top surface of a splitting block. The log retainer apparatus may also include a short strap to removably attach to shield or shields of at least a subset of the plurality of retainer segments, and a long strap to wrap around the clamps of the plurality of retainer segments to secure the log retainer apparatus to the splitting block.

### CROSS-REFERENCE TO RELATED APPLICATION(S)

This application claims priority to U.S. Provisional Patent Application Ser. No. 63/491,656, filed on Mar. 22, 2023, which is incorporated herein by reference in its entirety.

### BACKGROUND

### 1. Field of the Embodiments

Embodiments of the present disclosure relate generally to log splitting devices, and more particularly to apparatus for preventing split logs from falling off a splitting block during log-splitting activities.

### 2. Description of Related Art

Wood or log-splitting activities are activities that have been around for centuries. Advancement in log-splitting technology has essentially remained unchained over the years. Typically, when a log or a piece of wood is to be split, they are first placed on top of a splitting block (e.g., a wood chopping block that is often made from a circular tree trunk), and an axe is swung down on the log or piece of wood to split the log or piece of wood. One problem encountered when the log or piece of wood is split, is that the split log or wood tends to fly away in all directions from the splitting block, making cleanup and gathering of the split logs cumbersome.

### BRIEF DESCRIPTION OF THE DRAWINGS

The present disclosure is illustrated by way of example, and not limitation, in the figures of the accompanying drawings, in which like reference numerals indicate similar elements and in which.

FIG. 1 illustrates an example log retainer apparatus according to various embodiments.

FIG. 2 illustrates a closeup view of one of the retainer segments illustrated in FIG. 1 according to various embodiments.

FIG. 3 illustrates how the log retainer apparatus of FIG. 1 may be deployed on a splitting block.

FIG. 4 illustrates another example log retainer apparatus with a catch according to various embodiments.

FIG. 5 illustrates the example log retainer apparatus of FIG. 4 from another perspective.

### DETAILED DESCRIPTION

In the present description, certain specific details are set forth in order to provide a thorough understanding of various embodiments of the disclosure. However, upon reviewing this disclosure one skilled in the art will understand that the various embodiments disclosed herein may be practiced without many of these details. In other instances, some well-known structures and materials of construction have not been described in detail to avoid unnecessarily obscuring the descriptions of the embodiments of the disclosure.

In the present disclosure, to the extent the terms “about” and “approximately,” are used, they mean±20% of the indicated range, value, or structure, unless otherwise indicated. In the present description, the terms “a” and “an” as used herein refer to “one or more” of the enumerated components. The use of the alternative (e.g., “or”) should be understood to mean either one, both, or any combination thereof of the alternatives. As used herein, the terms “include” and “comprise” are used synonymously, the terms and variants of which are intended to be construed as non-limiting. The definitions in this paragraph are intended to apply throughout this disclosure unless otherwise expressly stated.

The drawings submitted herewith include example information depicted for illustrative purposes and are not intended to be limiting unless otherwise indicated.

According to various embodiments of the present disclosure, a log retainer apparatus is described herein for preventing logs or wood blocks (hereinafter simply “logs”) that have been split from scattering away from a splitting block (e.g., chopping block) when the logs are being split or chopped on the splitting block. Splitting blocks are commonly made from round tree trunks. The log retainer apparatus may be deployed on and around the top surface of a splitting block to prevent.

In some embodiments, the log retainer apparatus may include a plurality of retainer segments, each retainer segment having a shield connected to a clamp to clamp to an edge of a top surface of a splitting block. The log retainer apparatus may further include a short strap to removably attach to shield or shields of at least a subset of the plurality of retainer segments, and a long strap to wrap around the clamps of the plurality of retainer segments.

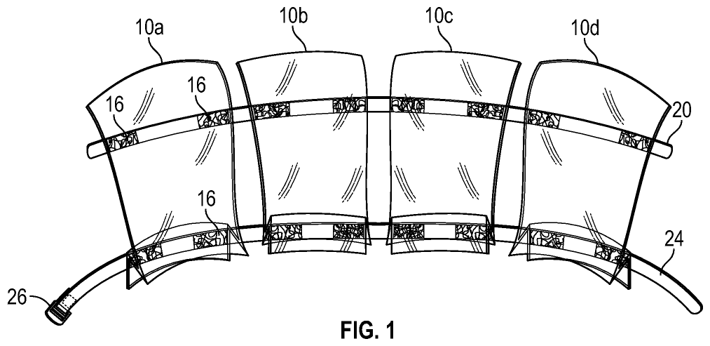

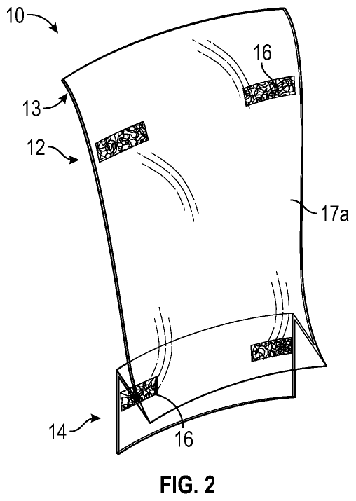

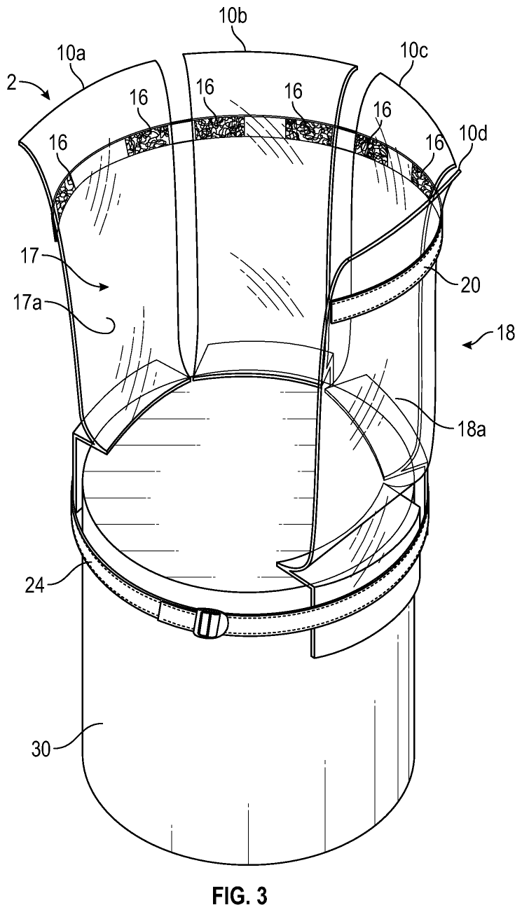

FIG. 1 illustrates an example log retainer apparatus 2 according to various embodiments. For the embodiments, the retainer apparatus 2 includes four retainer segments 10a, 10b, 10c, and 10d that may be removably connected or linked to each other via a short strap 20 and a long strap 24. FIG. 2 illustrates a close-up view of one of the retainer segments 10a, 10b, 10c, and 10d illustrated in FIG. 1 in accordance with some embodiments, while FIG. 3 shows the retainer apparatus 2 of FIG. 1 deployed on a splitting block 30. Note that for purposes of the following, “*” represents a wildcard. Thus, references to, for example, a retainer segment 10* may be in reference to retainer segment 10a, retainer segment 10b, retainer segment 10c, or retainer segment 10d.

As will be referenced in the following, the retainer apparatus 2 has two opposing or opposite sides, an inward side 17 and an outward side 18 opposite of the inward side 17, where the outward side 18 faces away from a splitting block 30 when the log retainer apparatus 2 is wrapped around a top portion of the splitting block 30 as illustrated in FIG. 3. Similarly, each retainer segment 10* may have an inward side 17a and an outward side 18a opposite of the inward side 17a (as shown in FIG. 3), where the outward side 18a faces away from a splitting block 30 when the log retainer apparatus 2 is wrapped around the top portion of the splitting block 30.

Referring particularly now to FIG. 2, each retainer segment 10* may comprise two portions, a shield 12 and a clamp 14 (which may be an L-shaped clamp) that is connected to the bottom of the shield 12. Clamp 14 may be used to clamp or hook to an edge of a top surface of a splitting block 30. In some implementations, both the shield 12 and the clamp 14 (e.g., L-shaped clamp) may be made of a single unitary material such as clear or translucent plastic. For example, in some cases, both the shield 12 and the clamp 14 may be made of polycarbonate, acrylic, polyethylene terephthalate glycol (PETG), or Polyvinyl Chloride (PVC).

As illustrated in FIG. 2, each retainer segment 10* may have a lateral inward curved shape that may generally trace the perimeter of a circular-shaped splitting block 30. Further, in various implementations, the top portion 13 of the retainer segment 10* or shield 12 may be curved outward. Disposed on the outward side of the retainer segment 10* are attachment strips 16 for attaching the retainer segment 10* to a short strap 20 and a long strap 24. In various embodiments, the attachment strips 16 may be hook and loop (HL) fastener strips (e.g., VELCRO strips) to attach to corresponding HL fastener strips on the short and long straps 20 and 24. Alternatively, other types of attachment means may be employed to attach the retainer segments 10* to the short and long straps 20 and 24.

In FIG. 2, the retainer segment 10* includes four attachment strips 16 disposed on the outward side of the retainer segment 10*. Two of the attachment strips 16 are disposed on the outward side of the shield 12 for attaching to the short strap 20 and two of the attachment strips 16 are disposed on the outward side of the clamp 14 for attaching to the long strap 24. Note that although FIGS. 1 and 2 show four attachment strips 16 disposed on the outward sides of each of the retainer segments 10*, in alternative embodiments, there may be fewer or more attachment strips 16 on the outward sides of the retainer segments 10*. For example, in some implementations, a retainer segment 10* may only have a pair of attachment strips 16-a single retainer strip 16 for attaching to the short strap 20 and a single retainer strip for attaching to the long strap 24.

In some embodiments, a first subset of the retainer segments 10* may be permanently affixed or attached to the short and long straps 20 and 24, while a second subset of the retainer segments 10* may be removably attached to the short and long straps 20 and 24 and vice versa (e.g., the first strap 20 and long strap 24 removably attached to a first set of retainer segments 10* and the first strap 20 and long strap 24 may be permanently affixed or attached to a second set of retainer segments 10*). For example, in some cases, a first set of retainer segments, retainer segments 10b and 10c of FIG. 1 may be permanently affixed to short and long straps 20 and 24 by various means (e.g., an adhesive such as glue or cement, nail, screw, etc.), while a second set of retainers, retainer segments 10a and 10d may be removably attached to the short and long straps 20 and 24 via, for example, HL fastener strips.

To deploy the log retainer apparatus 2, the long strap 24 may be wrapped around the upper portion of a splitting block 30 as illustrated in FIG. 3. The log retainer apparatus 2, as shown in FIG. 3 has an inward side 17 and an outward side 18 opposite of the inward side 17 that faces inwards when the log retainer apparatus 2 is deployed on a splitting log 30. Similarly, each retainer segment 10* has an inward side 17a and an outward side 18a opposite of the inward side 17a. Since the long strap 24 runs along the outward or outer sides of the clamps 14 of the retainer segments 10*, when the long strap 24 is tightened via, for example, a buckle 26, the clamps 14 (e.g., L-shaped clamps) of the retainer segment 10* are forced to clamp or lock on to the edge of the top surface of the splitting block 30.

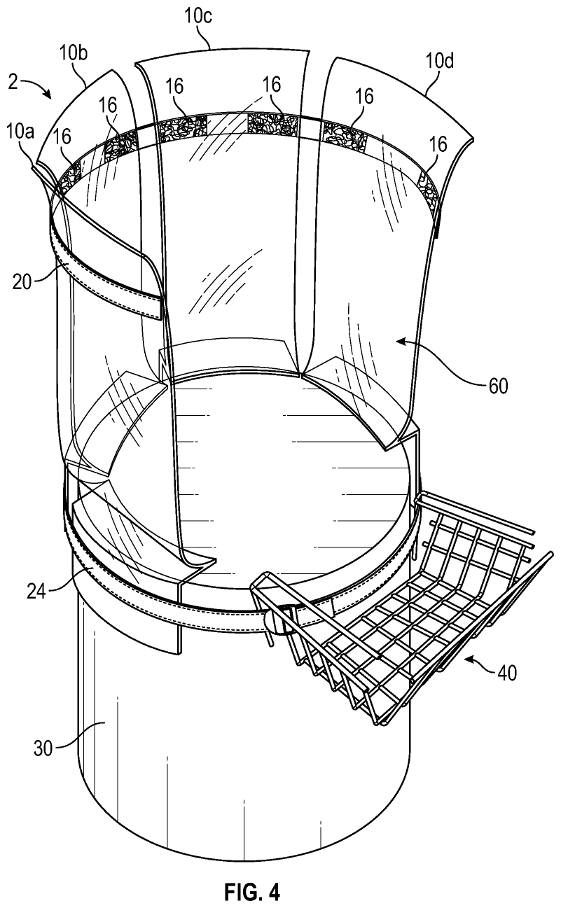

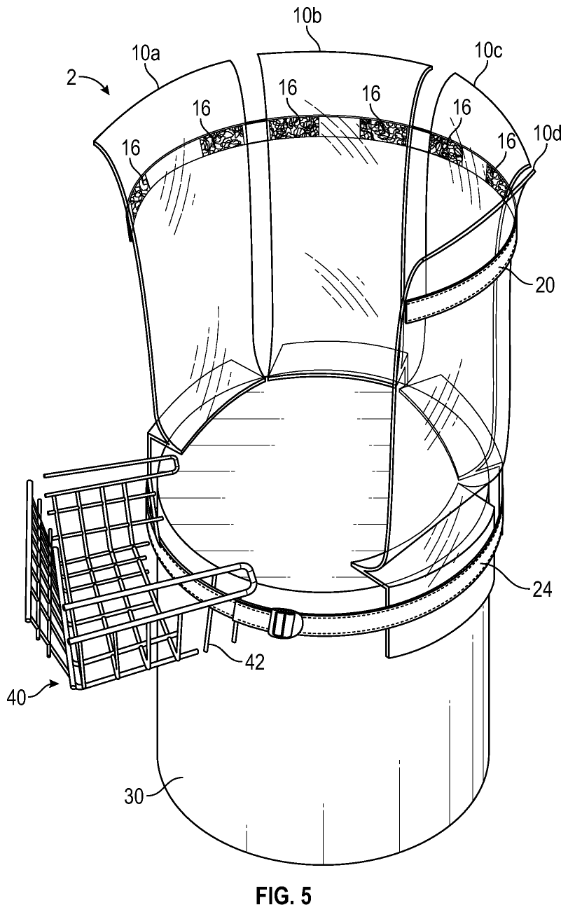

FIGS. 4 and 5 illustrate different views of another example log retainer apparatus 102 according to some example embodiments. For the embodiments, the log retainer apparatus 102 includes the same features and components of those of log retainer apparatus 2 of FIGS. 1 and 3. In addition, log retainer apparatus 2 further includes a catch 40 to catch split logs that falls off the splitting block 30 through opening 60 during log splitting activities. In the implementation illustrated in FIG. 4, the catch 40 is a basket. In alternative implementations, the catch 40 may be a bag, a pouch, a tray, or other structure for catching and holding split logs.

Various means may be employed to attach or secure the catch 40 to the log retainer apparatus 102 in various alternative embodiments. For example, in FIG. 5, the catch 40 is shown to be secured to the log retainer apparatus 102 by inserting spokes 42 of the catch 40 between the splitting block 30 and the long strap 24 that has been tightened around the splitting block 30. In other embodiments, one or more clamps may be used to secure the catch 40 to the long strap 24. In still other embodiments, the catch 40 rather than being secured to the log retainer apparatus 102 may be secured to the splitting block 30 with, for example, one or more stakes or by other means.

In some alternative embodiments, the log retainer apparatus may be made primarily of a single unitary material such as rubber, silicon or other types of resilient/flexible material. For these embodiments, the log retainer apparatus, which will be referred to herein as a “unitary log retainer apparatus,” may not comprise of multiple and separate retainer segments as illustrated in FIGS. 1-5, but instead, may comprise of a single unitary retainer segment that partially or substantially wraps around the top portion of a splitting block 30 similar to how the multiple retainer segments 10* of the log retainer apparatuses 2 and 102 illustrated in FIGS. 1-5 wraps around the top portion of a splitting block 30. Various approaches may be employed in order to secure the unitary log retainer apparatus to a top portion of a splitting block 30. For example, in some cases, a strap, such as the long strap 24 of FIGS. 1, and 3-5 may be used to secure the unitary log retainer apparatus to the top portion of a splitting block 30. Alternative means may also be employed to secure the unitary log retainer apparatus to the top portion of a splitting block 30 in various alternative embodiments.

The various embodiments described herein, have been presented as non-limiting example embodiments of the present disclosure, unless otherwise expressly indicated. After reviewing the present disclosure, an individual of ordinary skill in the art will immediately appreciate that some details and features can be added, removed and/or changed without deviating from the spirit of the disclosure. Reference throughout this specification to “various embodiments,” “one embodiment,” “an embodiment,” “additional embodiment(s)”, “alternative embodiments,” or “some embodiments,” means that a particular feature, structure or characteristic described in connection with the embodiment(s) is included in at least one or some embodiment(s), but not necessarily all embodiments, such that the references do not necessarily refer to the same embodiment (s). Furthermore, the particular features, structures, or characteristics may be combined in any suitable manner in one or more embodiments. These and other changes can be made to the embodiments in light of the above-detailed description. In general, in the following claims, the terms used should not be construed to limit the claims to the specific embodiments disclosed in the specification, but should be construed to include all possible embodiments along with the full scope of equivalents to which such claims are entitled. Accordingly, the claims are not limited by the disclosure.

What is claimed is:

1. A log retainer apparatus, comprising:
a plurality of retainer segments, each retainer segment having a shield connected to a clamp to clamp to an edge of a top surface of a splitting block;
a short strap to removably attach to shield or shields of at least a subset of the plurality of retainer segments; and
a long strap to wrap around the clamps of the plurality of retainer segments to secure the log retainer apparatus to the splitting block.

2. The log retainer apparatus of claim 1, wherein each retainer segment having an inward side and an outward side opposite of the inward side and having a lateral inward curved shape, the outward side facing away from the splitting block when the log retainer apparatus is wrapped around a top portion of the splitting block.

3. The log retainer apparatus of claim 2, wherein a top portion of the shield of each retainer segment is curved outward, the top portion of the shield of each retainer segment is opposite from where the shield of each retainer segment is connected to a respective L-shaped clamp.

4. The log retainer apparatus of claim 2, wherein on an outward side of at least one of the plurality of retainer segments are two or more attachment strips to attach to the short strap and the long strap.

5. The log retainer apparatus of claim 4, wherein the two or more attachment strips are two or more hook and loop fastener strips to attach to corresponding hook and loop fastener strips on the short strap and the long strap.

6. The log retainer apparatus of claim 1, wherein the clamp is an L-shaped clamp.

7. The log retainer apparatus of claim 1, wherein the long strap includes a buckle to tighten the strap around the plurality of retainer segments.

8. The log retainer apparatus of claim 1, wherein the short strap is affixed to shield or shields of another subset of the plurality of retainer segments.

9. The log retainer apparatus of claim 1, further comprising a catch to catch split logs falling off the splitting block.

10. The log retainer apparatus of claim 9, wherein the catch is a basket.

11. The log retainer apparatus of claim 9, wherein the catch includes spokes to insert between the long strap and the splitting block.

12. The log retainer apparatus of claim 9, wherein the catch includes one or more clamps to secure the catch to the long strap.

13. The log retainer apparatus of claim 1, wherein one or more of the plurality of retainer segments is or are made of clear plastic.

14. The log retainer apparatus of claim 13, wherein the clear plastic is polycarbonate, acrylic, polyethylene terephthalate glycol (PETG), or Polyvinyl Chloride (PVC).

15. A log retainer apparatus, comprising:
a retainer segment having a shield connected to a clamp to clamp to an edge of a top surface of a splitting block;
a strap to strap the clamp to the a top portion of a splitting block; and
a catch to catch split logs falling off the splitting block.
